(19) United States
(12) Patent Application Publication
(10) Pub. No.: US 2017/0344039 A1
(43) Pub. Date: Nov. 30, 2017

(54) Arcless Tap Changer Using Gated Semiconductor Devices

(71) Applicant: COOPER TECHNOLOGIES COMPANY, HOUSTON, TX (US)

(72) Inventors: Frederick Alan Stich, Wisconsin Rapids, WI (US); Tiefu Zhao, Menomonee Falls, WI (US)

(73) Assignee: COOPER TECHNOLOGIES COMPANY, HOUSTON, TX (US)

(21) Appl. No.: 15/167,739

(22) Filed: May 27, 2016

(51) Int. Cl. G05F 1/20

(52) U.S. Cl. CPC G05F 1/20

(57) ABSTRACT

A voltage regulator includes a tap changer coupled to a voltage source terminal and a voltage load terminal, The voltage regulator also includes a first switch and a first current transformer coupled in series between the voltage load terminal and a first movable contact of the tap changer. The voltage regulator further includes a second switch and a second transformer coupled in series between the voltage load terminal and a second movable contact of the tap changer, A first silicon controlled rectifier and a second silicon controlled rectifier are controlled by a first control circuit and a second control circuit, respectively. The first control circuit and the second control circuit each include a rectifier, a gating switch, and a positive voltage detector.

### TECHNICAL FIELD

Embodiments described herein relate generally to voltage regulators, and more particularly to systems, methods, and devices for controlling a gated semiconductor device in an arcless tap changer of a voltage regulator.

### BACKGROUND

Tap changers are used in medium voltage auto-transformer-based voltage regulators to regulate the output voltage. Medium voltage auto-transformer-based voltage regulators typically operate in the range of 2 kV AC to 30 kV AC. The tap changers regulate the output voltage by compensating for input voltage changes and load (current) induced changes. These tap changers typically have autotransformer windings with eight stationary taps. FIGS. 1A-1B, and 1C illustrate an example of a tap changer 100 of a voltage regulator known in the prior art and show the switching sequence as the movable contacts within the tap changer move from stationary tap #2 to stationary taps #1 and #2. The tap changer 100, as shown in FIGS. 1A-1C. includes a source terminal 105, a load terminal 110, a raise/lower switch 115, a neutral position tap 125, and a series winding 120 to which are coupled eight stationary taps 130 that are numbered 1 through 8. Alternate tap changers may have more or fewer taps. The tap changer 100 also has two movable contacts 132 and 134 that can both be on one tap or on adjacent taps When the movable contacts 132 and 134 are on adjacent taps, the output is ½ the difference between the two taps. The output inductor 136, also referred to as the bridging reactor or preventive autotransformer winding, is electrically coupled to the series winding 120 through the tap switches, The output inductor 136 is coupled to the movable contacts 132 and 134 and ensures current sharing between the current paths of the two movable contacts 132 and 134.

Whenever a movable contact moves off of one stationary tap (i.e, breaks), arcing can occur due to current flow and circuit inductance. Additionally, whenever a moveable contact moves onto a stationary tap (i.e. makes), arcing can also occur. This arcing process causes contact wear and causes contaminants, such as carbon, to be added to the insulating medium, typically a dielectric fluid referred to as transformer oil, which reduces the useful life of the tap changer within a voltage regulator. Maintenance of substation equipment to replace voltage regulators requires extensive bypass procedures to maintain power on the distribution circuit and has associated costs. A tap changer that eliminates arcing (referred to herein as an arcless or non-arcing tap changer) eliminates arcing from occurring during a tap change operation by shunting one movable contact. Arcless tap changers therefore are desirable because they extend the life of tap changer contacts by eliminating electrical arcing during a tap switching operation and they reduce the likelihood of electrical failures within the voltage regulator due to carbon buildup in the dielectric fluid.

A voltage regulator with an arcless tap changer is described in prior U.S. Pat. No. 3,617,862 (“the '862 patent”), which is hereby incorporated herein by reference. The arcless tap changer in the '862 patent utilizes an arrangement of capacitors and a pair of silicon controlled rectifiers (SCRs) 80 and 81 that gradually turn off current to the movable contacts in the tap changer thereby eliminating, arcing when a tap change operation occurs. The arrangement of the power circuit and the SCRs 80 and 81 in the '862 patent requires continuous gate current flowing to the SCRs 80 and 81 when load current flows through both auxiliary switches AB and AD. However, this requirement for continuous gate current to the SCRs 80 and 81 imposes limitations on the voltage regulator if the intended application needs to span a large current range. For example, if the minimum load current for gating the SCRs is 10 amps and the minimum SCR trigger current is 100 milliamps, these values require a turns ratio of less than 100 for the current transformers supplying gate current. However, the current transformers in the power circuit of the voltage regulator need to be rated to handle fault currents of 10's of kA. Fault current can initiate at the crest of the power signal wave prior to any saturating effects, and the secondary current would be correspondingly large.

An additional limitation with the power circuit shown in the '862 patent is that the gate-cathode junction of the SCRs cannot dissipate more than 2 watts continuously during the time of high load current. This constraint on the power dissipation of the SCRs requires that gate current be limited to modest levels in the range of a few 100 milliamps. On the other hand high levels of gate current in the range of 1-3 amps are required to cope with high rates of change of anode current when the SCRs are initially conducting due to the opening of an auxiliary contact AB or AD as shown in the power circuit of the '862 patent. These two requirements are not compatible and affect reliability when continuous gate currents are employed in the power circuit of the '862 patent. A further drawback of the power circuit in the '862 patent is that the use of continuous, high-current gate control circuits requires that the rectified power for the control circuits be filtered by large capacitors, such as electrolytic capacitors. Large capacitors, such as electrolyte capacitors, are largely incompatible with the hot-oil environment of a voltage regulator tank.

Therefore, an improvement is needed to voltage regulators, such as the one shown in the '862 patent, so that the current transformer turns ratio can be increased in order to have a range of manageable secondary currents, while also having a useful gate current.

### SUMMARY

In general, in one aspect, the disclosure relates to controlling a tap changer of a voltage regulator. The present disclosure is an improvement on the voltage regulator described in the '862 patent in that the power circuit and the SCRs are controlled differently for improved performance. The tap changer comprises a voltage source terminal, a plurality of stationary taps, a first movable contact, and a second movable contact. The first movable contact is coupled to a first switch and a first current transformer of the voltage regulator. The second movable contact is coupled to a second switch and a second current transformer of the voltage regulator. The voltage regulator further comprises a first control circuit coupled to the first current transformer, the second current transformer, and a first silicon controlled rectifier (SCR) and a second control circuit coupled to the first current transformer, the second current transformer, and the second silicon controlled rectifier (SCR). The first SCR and the second SCR are oriented anti-parallel to each other and in parallel with a voltage load terminal. Each of the first control circuit and the second control circuit comprise a first rectifier, second rectifier, a gating switch that supplies a gating signal to an SCR gate, and a positive voltage detector coupled to an SCR anode and providing a signal to the gating switch.

In another aspect, the disclosure can relate to a method for operating a voltage regulator comprising the steps of supplying a load current from a source terminal to a load terminal through a tap changer of the voltage regulator. The tap changer comprising a first movable contact in contact with a first stationary tap and a second movable contact also in contact with the first stationary tap. The first movable contact is coupled to a first switch and a first current transformer of the voltage regulator. The second movable contact is coupled to a second switch and a second current transformer of the voltage regulator. The voltage regulator further comprises a first control circuit coupled to the first and second current transformers and a first silicon controlled rectifier (SCR) and a second control circuit coupled to the first and second current transformers and the second silicon controlled rectifier (SCR). The method further includes the steps of initiating a tap change of the voltage regulator by opening the first switch thereby causing the first SCR and the second SCR to each assume load current dependent on the polarity of the load current at the time of the switch opening through the action of the gating signals to be applied to a gate of the first SCR and a gate of the second SCR. In the next step of the method, the gating signal is removed from the gate of the first SCR and the gate of the second SCR causing the first SCR and the second SCR to turn off when the load current next equals zero. Once the first SCR and the second SCR have turned of the tap changer moves the first movable contact from the first stationary tap to a second stationary tap. After the movement of the movable contact is compete, the first switch of the voltage regulator is closed and the first control circuit and the second control circuit are prepared to apply a gating signal to a gate of the first SCR and a gate of the second SCR.

In yet another aspect, the disclosure relates to controlling a tap changer of a voltage regulator using gated semiconductor devices. The tap changer composes a voltage source terminal, a plurality of stationary taps, a first movable contact, and a second movable contact. The first movable contact is coupled to a first switch of the voltage regulator. The second movable contact is coupled to a second switch of the voltage regulator. The voltage regulator further comprises a first control circuit coupled to a first current sensor, a power supply and a first gated semiconductor device and a second control circuit coupled to a second current sensor, the power supply, and a second gated semiconductor device. The first gated semiconductor device and the second gated semiconductor device are oriented anti-parallel to each other and in parallel with a voltage load terminal. Each of the first control circuit and the second control circuit comprise a rectifier, a gating switch that supplies a gating signal to the gated semiconductor device, and a positive voltage detector coupled to an anode of the gated semiconductor device and providing a signal to the gating switch.

These and other aspects, objects, features, and embodiments will be apparent from the following description and the appended claims.

### BRIEF DESCRIPTION OF THE DRAWINGS

The drawings illustrate only example embodiments of non-arcing tap changers of a voltage regulator and are therefore not to be considered limiting of its scope, as non-arcing tap changers of voltage regulators may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A, 1B, and 1C show an example tap change operation of a tap changer known in the prior art.

FIG. 2A shows a schematic diagram for a tap changing voltage regulator in accordance with certain example embodiments of the disclosure.

FIG. 2B shows a detailed diagram of current transformer components of a tap changing voltage regulator in accordance with certain example embodiments of the disclosure.

FIG. 3 shows a schematic diagram for a tap changing voltage regulator in accordance with another example embodiment of the disclosure.

FIG. 4 shows a schematic diagram of SCR control circuit components of a tap changing voltage regulator in accordance with certain example embodiments of the disclosure.

FIG. 5 shows a detailed schematic diagram of SCR control circuit components of a tap changing voltage regulator in accordance with certain example embodiments of the disclosure.

FIGS. 6, 7, 8. 9, 10, and 11 illustrate an example tap changing operation for a voltage regulator in accordance with certain example embodiments of the disclosure.

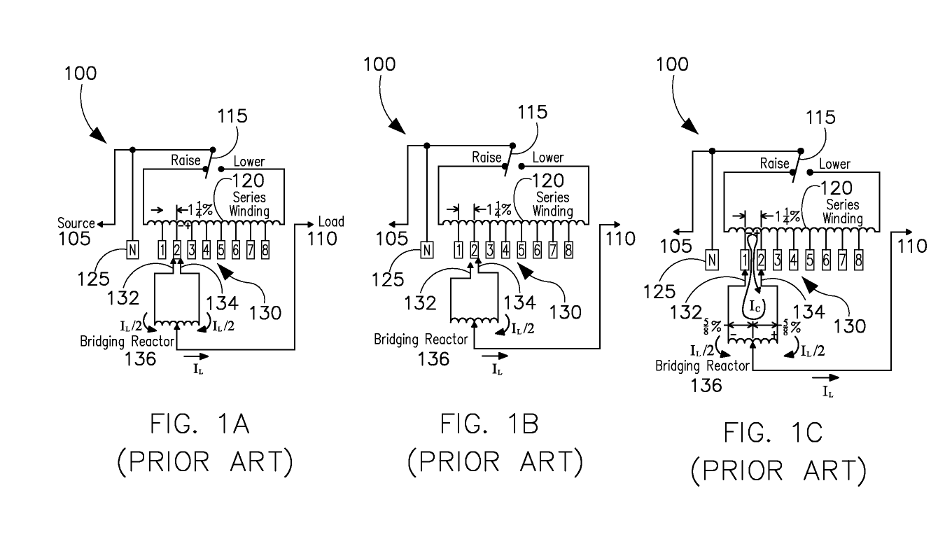

### DETAILED DESCRIPTION OF EXAMPLE EMBODIMENTS

The example embodiments discussed herein are directed to systems, apparatuses, and methods of controlling a tap changer of a medium voltage transformer-based voltage regulator. The present disclosure is an improvement on the voltage regulator described in the '862 patent in that the power circuit and the SCRs are controlled differently for improved performance.

While example embodiments are described herein as being directed to voltage regulators used in medium voltage electric distribution systems of a power grid, example embodiments can also be used with voltage regulators in other types of systems. As described herein, a user can be any person who interacts with a voltage regulator. Examples of a user may include, but are not limited to, a consumer, an electrician, an engineer, a lineman, a consultant, a contractor, an instrumentation and controls technician, an operator, and a manufacturer's representative.

In one or more example embodiments, a voltage regulator is subject to meeting certain standards and/or requirements. Examples of entities that set and/or maintain such standards can include, but are not limited to, the International Electrotechnical Commission (IEC), the National Electric Code (NEC), the National Electrical Manufacturers Association (NEMA), and the Institute of Electrical and Electronics Engineers (IEEE). Example embodiments are designed to be used in compliance with any applicable standards and/or regulations.

As described herein, communication between two or more components of an example voltage regulator is the transfer of any of a number of types of signals. Examples of signals can include, but are not limited to, power signals, control signals, communication signals, data signals, instructions, and status reporting. In other words, communication between components of example voltage regulators can involve the transfer of power (e.g., high levels of current, high levels of voltage), control (e.g., low voltage, low current), and/or data.

Any component described in one or more figures herein can apply to any subsequent figures having the same label. In other words, the description for any component of a subsequent (or other) figure can be considered substantially the same as the corresponding component described with respect to a previous (or other) figure. For any figure shown and described herein, one or more of the components may be omitted, added, repeated, and/or substituted. Accordingly, embodiments shown in a particular figure should not be considered limited to the specific arrangements of components shown in such figure.

Example embodiments of systems and methods for controlling a switching module of a voltage regulator will be described more full hereinafter with reference to the accompanying drawings, in which example voltage regulator systems are shown. Voltage regulator systems may, however, be embodied in many different forms and should not be construed as limited to the example embodiments set forth herein. Rather, these example embodiments are provided so that this disclosure will be thorough and complete, and will fully convey the scope of voltage regulator systems to those of ordinary skill in the art. Like, but not necessarily the same, elements (also sometimes called components) in the various figures are denoted by like reference numerals for consistency.

Terms such as “first” and “second” are used merely to distinguish one component (or part of a component or state of a component) from another. Such terms are not meant to denote preference or a particular orientation. Also, the names given to various components described herein are descriptive of one embodiment and are not meant to be limiting in any way. Those of ordinary skill in the art will appreciate that a feature and/or component shown and/or described in one embodiment (e.g., in a figure) herein can be used in another embodiment (e.g., in any other figure) herein, even if not expressly shown and/or described in such other embodiment.

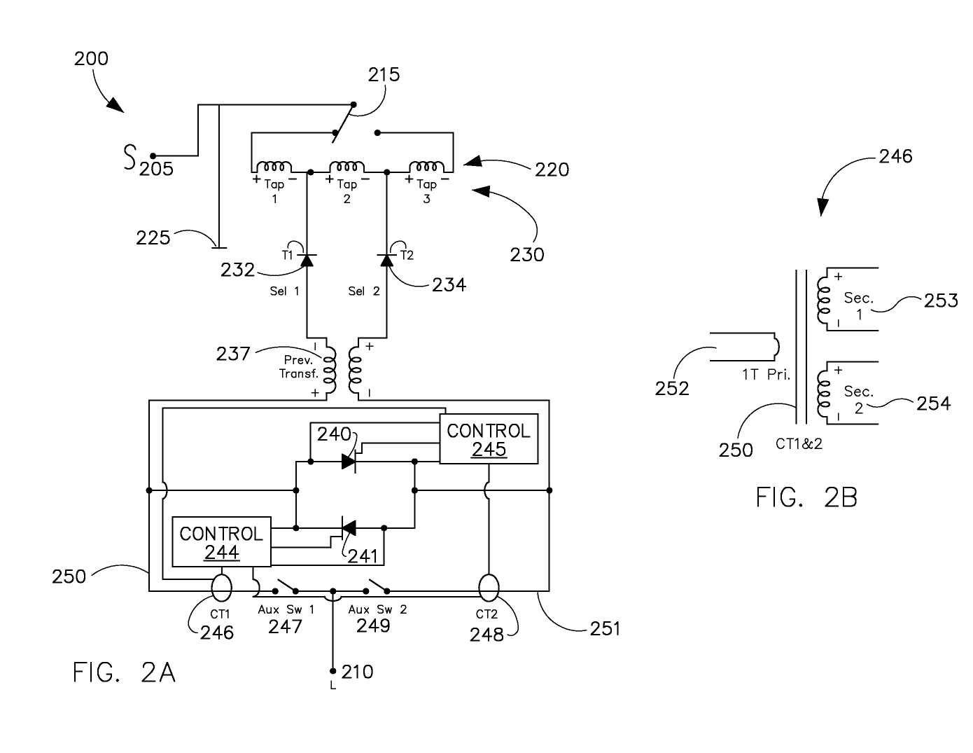

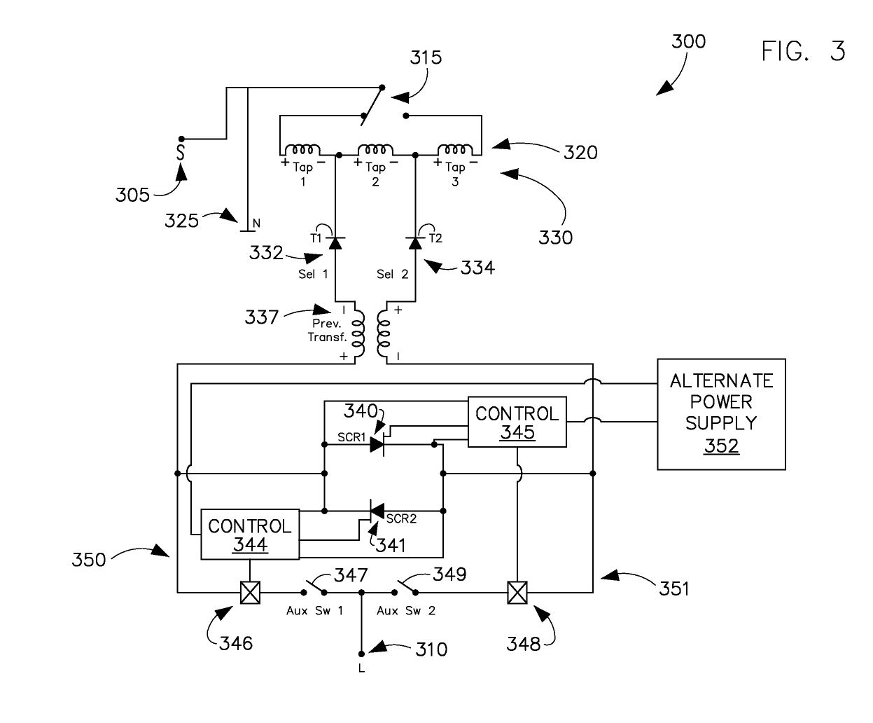

Referring now to FIG. 2A, a schematic diagram is shown of an example voltage regulator 200 in accordance with the embodiments disclosed herein. The voltage regulator 200 has similarities to the voltage regulator described in the prior art '862 patent, however, voltage regulator 200 has unique current transformers and control circuits that provide improved performance as will be described further in connection with FIG. 2A and the remaining figures herein. Voltage regulator 200 comprises a voltage source terminal 205, a voltage load terminal 210, and a tap changer that comprises a raise/lower switch 215, a neutral position tap 225, and a series winding 220 to which are coupled stationary taps 230. Although only two stationary taps, labeled T1 and T2, are illustrated for simplicity in the example voltage regulator 200, it should be understood that embodiments of this disclosure can include more than two stationary taps. A first movable contact 232 and a second movable contact 234 are shown in contact with stationary taps T1 and T2, respectively, in FIG. 2A.

Voltage regulator 200 includes a preventive transformer 237, comprising a first and second winding, that provides an impedance to prevent short-circuits during tap change. In alternate embodiments, reactors other than a preventive transformer may be implemented. In the example shown in FIG. 2A, the preventive transformer 237 is coupled to conductors 250 and 251. Conductor 250 couples the first movable contact 232 (through the first preventive transformer winding) to voltage load terminal 210 and conductor 251 couples the second movable contact 234 (through the second preventive transformer winding) to voltage load terminal 210. A first current transformer 246 and a first switch 247 are coupled in series along conductor 250 and a second current transformer 248 and a second switch 249 are coupled in series along conductor 251. Each of the first current transformer 246 and the second current transformer 248 comprise a primary coil and two secondary coils. The example provided in FIG. 28 of the first current transformer 246 shows the arrangement of the primary coil 252 on one side of conductor 250 and the two secondary coils 253 and 254 positioned on the opposite side of conductor 250. The same arrangement of the primary coil and two secondary coils shown in FIG. 2B can apply to the second current transformer 248.

The two secondary coils of the first current transformer 246 and the second current transformer 248 sense current and provide power to the first control circuit 244 and the second control circuit 245. The first current transformer 246 and the second current transformer 248 can have non-linear characteristics and are not intended for current measurement because they are designed to span a large range of primary current, for example 10 to 2000 amperes of continuous current and even larger ranges for short duration surge currents. The ratio of turns between the primary coil and the secondary coils in the first current transformer 246 and the second current transformer 248 is greater than 100 in certain example embodiments and 1000 or greater in additional example embodiments.

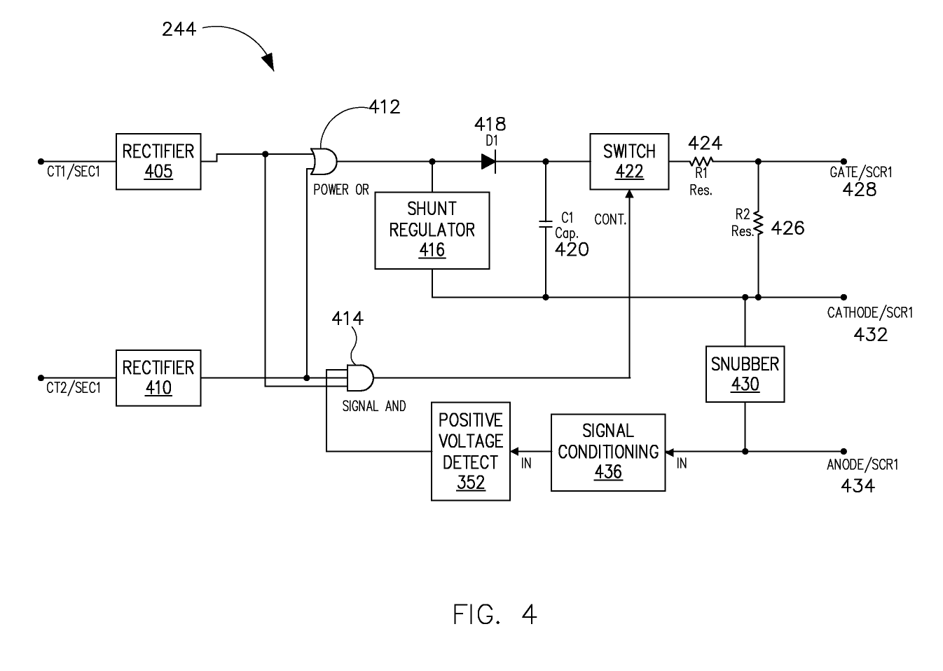

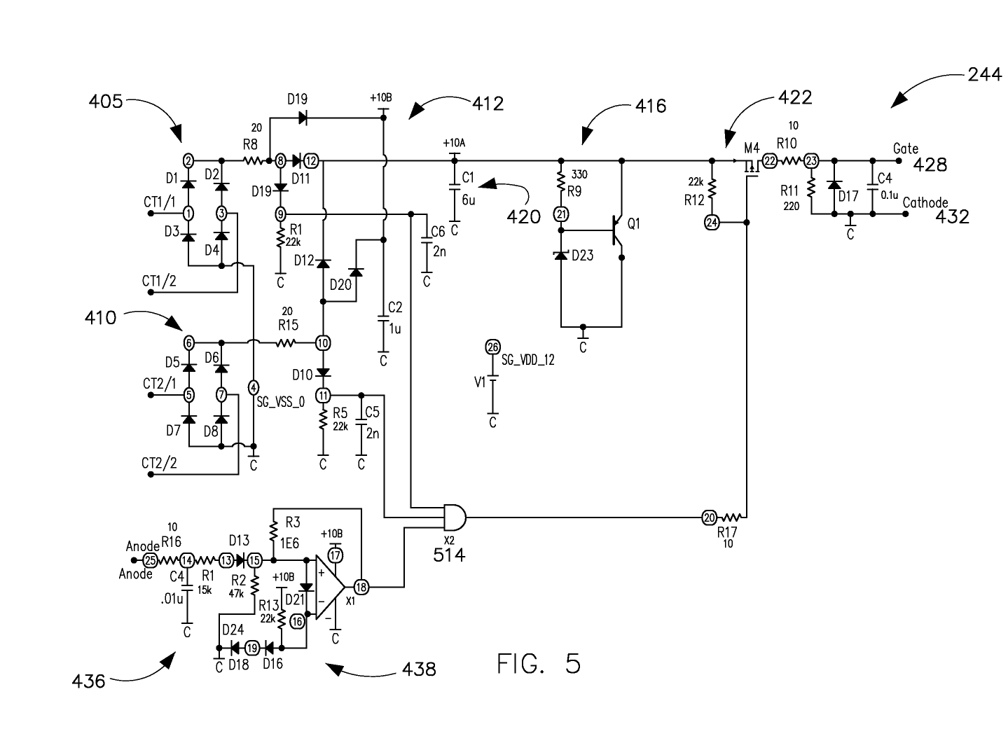

The first control circuit 244 controls the first silicon controlled rectifier (“first SCR”) 241 and the second control circuit 245 controls the second silicon controlled rectifier (“second SCR”) 240. The connections between the first control circuit 244 and the first and second current transformers 246 and 248, and the connections between the second control circuit 245 and the first and second current transformers 246 and 248 are simplified in FIG. 2A for the sake of providing an illustrative example. The connections and components of an example control circuit are shown in greater detail in FIGS. 4 and 5 and are described further below. As will be described further below, the first SCR 241 and the second SCR 240 can interrupt the flow of current to the first movable contact 232 and the second movable contact 234 respectively, before a tap change occurs and thereby eliminate arcing at the movable contacts. Although the example embodiments provided herein describe the use of SCRs to perform the current interrupting function, in alternate embodiments other types of switching devices can be used in place of the SCRs.

FIG. 3 illustrates another example embodiment of a voltage regulator in accordance with the current disclosure. Specifically, the voltage regulator 300 includes many of the same components described in connection with the voltage regulator 200 of FIG. 2. Briefly, voltage regulator 300 comprises a voltage source terminal 305, a voltage load terminal 310, and a tap changer that comprises a raise/lower switch 315, a neutral position tap 325, and a series winding 320 to which are coupled to stationary taps 330. A first movable contact 332 and a second movable contact 334 are shown in contact with stationary taps T1 and T2, respectively. Similar to FIG. 2A, voltage regulator 300 also comprises a preventive transformer 337 with a first and second winding. Conductor 350 couples the first movable contact 332 (through the first preventive transformer winding) to voltage load terminal 210 and conductor 251 couples the second movable contact 334 (through the second preventive transformer winding) to voltage load terminal 710.

The voltage regulator 300 differs from the voltage regulator 200 in several aspects. First, instead of two current transformers supplying power to the control circuits 344 and 345 voltage regulator 300 comprises an alternative power supply 352 which may derive power from a single current or a voltage transformer with two isolated outputs. As shown in FIG. 3, the alternative power supply 352 supplies power to both the first control circuit 344 and the second control circuit 345. Except for this difference in the power source, the control circuits 344 and 345 are substantially the same as the control circuits 244 and 245 of FIG. 2. Although not shown in FIG. 3, for the sake of simplicity, it should be understood that the alternative power supply 352 comprises at least a primary coil and a pair of secondary coils as shown in FIG. 2B and further comprises electrical leads connecting the alternative power supply 352 to the control circuits 344 and 345. It should also be understood that in alternate embodiments other sources of power, such as a voltage transformer or other windings in other locations within the voltage regulator, can be used to power the control circuits.

Voltage regulator 300 further differs from voltage regulator 200 in that Hall effect sensors 346 and 348 are used to sense current in conductors 350 and 351, respectively. The Hall effect sensors 346 and 348 are coupled to the control circuits 344 and 345 and provide signals indicating when the current turns on and off in the conductors 350 and 351. The signals from the Hall effect sensors 346 and 348 can be used in the control circuits 344 and 345 as a substitute for the signals provided by the current transformers in voltage regulator 200. It should also be understood that in alternate embodiments of the disclosure other sensing devices can be used.

Lastly, voltage regulator 300 differs from voltage regulator 200 in that gated semiconductor devices 340 and 341 are used in place of SCRs 240 and 241. Gated semiconductor devices 340 and 341 operate in a similar manner to SCRs 240 and 241 in that they are coupled to the control circuits 344 and 345. The explanation of SCRs 240 and 241 herein is applicable to gated semiconductor devices 340 and 341. Examples of different types of gated semiconductor devices that can be implemented in voltage regulator 300 include insulated gate bipolar transistors, integrated gate-commutated thyristors, gate turn of thyristors, other wide-bandgap semiconductor devices, or a combination of the foregoing described semiconductor devices.

Referring now to FIG. 4, an example control circuit 244 that can be implemented in the voltage regulator 200 of FIG. 2 is illustrated and described. The components and operation of control circuit 245 are substantially identical to that of control circuit 244 and therefore, the following explanation of control circuit 244 applies equally to control circuit 245 illustrated in FIG. 2. It should also be understood that, other than the power source and the sensors being different as described in connection with FIG. 3, the description of the control circuit 244 in connection with FIG. 4 also applies to control circuits 344 and 345 of FIG. 3, with minor changes to the interface with alternative current sensors and power sources as would be understood by those in this field. As shown in FIG. 4, control circuit 244 comprises a first rectifier 405 connected to a secondary coil of the first current transformer 246 and a second rectifier 410 connected to a secondary coil of the second current transformer 248. The currents supplied by the secondary coils of first current transformer 246 and the second current transformer 248 are rectified and charge capacitor 420 through power OR gate 412. In the example embodiments provided herein, the capacitor 420 is a film capacitor on the order of 3 microfarads. In one example, if the ratio of turns on the first and second current transformers 246 and 248 is 1000:1, the capacitor 420 would be charged to 10 V in less than 6 milliseconds at a small load current of 10 Å.

Unlike the prior art voltage regulator described in the '862 patent wherein a continuous gating current to the SCR interrupters was required, in the control circuit 244 gating of the SCRs takes place only when necessary so that the capacitor 420 is not continuously drained. The control circuit 244 is connected to the first SCR 240 at the gate 428, cathode 432 and anode 434. The gating signal to the first SCR 240 is controlled by the signal AND gate 414. The signal AND gate 414 is arranged to turn on a gating switch 22 only when both the first and second current transformers 246 and 248 have current flow, and there is a positive voltage at the anode 434 of the first SCR 240. The control circuit 244 detects the voltage at the anode 434 and conditions the voltage received from the anode at signal conditioner 436. If the positive voltage detector 438 detects a positive voltage from the conditioned voltage received from the anode 434, the voltage is applied to the signal AND gate 414.

When the voltage regulator 200 is in operation and first switch 247 begins to open, both the first and second current transformers 246 and 748 will have current flow and the positive voltage detector 438 may detect a positive voltage at the anode 434 of the first SCR 241. This combination of three signals at the signal AND gate 414 will exist when there is a potential for incipient arcing at the tap changer. Upon receiving this combination of three signals, the signal AND gate 414 will turn on the gating switch 422 thereby providing a gating current through resistor 424 to the gate 428 of the first SCR 241 when the first SCR 241 has a positive anode voltage. Similarly, control circuit 245 would provide gating current to the gate of the second SCR 240 when the first and second current transformers 246 and 248 have current flow and the control circuit 245 detects a positive voltage at the anode of the second SCR 240. Providing the gating current to the first SCR 241 or the second SCR 240 then eliminates arcing when moving the movable contact 232 of the tap changer. In some example embodiments, at least a voltage of 10 V across first switch 247 with simultaneous current is needed tor arcing to occur. The example embodiments described herein are designed such that the gating switch 422 is turned on when a voltage of 2 V exists across the first switch 247 or the second switch 249.

The example control circuit 244 also includes a diode 418 and a shunt regulator 416 placed in parallel to the capacitor 420 to regulate the capacitor voltage and to drain away excess current from the first and second current transformers 246 and 248. The example control circuit 244 also includes a snubber 430 disposed between the cathode 432 and the anode 434 to handle transient voltages and a resistor 426 disposed between the gate 428 and the cathode 432.

Referring now to FIG. 5, a more detailed schematic of the control circuit 244 is illustrated. It should be understood that the schematic provided in FIG. 5 is only one example for implementing the control circuits 244 and 245 and that in alternate embodiments different components and different arrangements of components may be implemented. Referring to the example shown in FIG. 5, rectifier 405 is shown comprising diodes D1, D2, D3, and D4 and rectifier 410 is shown comprising diodes D5, D6, D7, and D8. The rectifiers 405 and 410 are coupled to the power OR gate 412 through resistors R6 and R15. The power OR gate 412 is implemented using diodes D1 and D12. The power OR gate 412 supplies a charging current to the capacitor 420 and the shunt regulator 416 is implemented with resistor R9, Zener diode and PNP bipolar transistor Q1. The gating switch 422 is implemented with transistor M4 and controls the supply of current through resistor R10 to gate 427. The gating switch 422 is controlled by the signal AND function implemented by NAND gate 514 which receives signals from the rectifiers 403 and 410 and the anode 434. The signal conditioner 436 comprises diode D13, capacitor C4 and resistors R16 and R1. The positive voltage detector 438 is implemented using diodes D16, D18, and D21, resistors R2, R13, and R3, and amplifier X1.

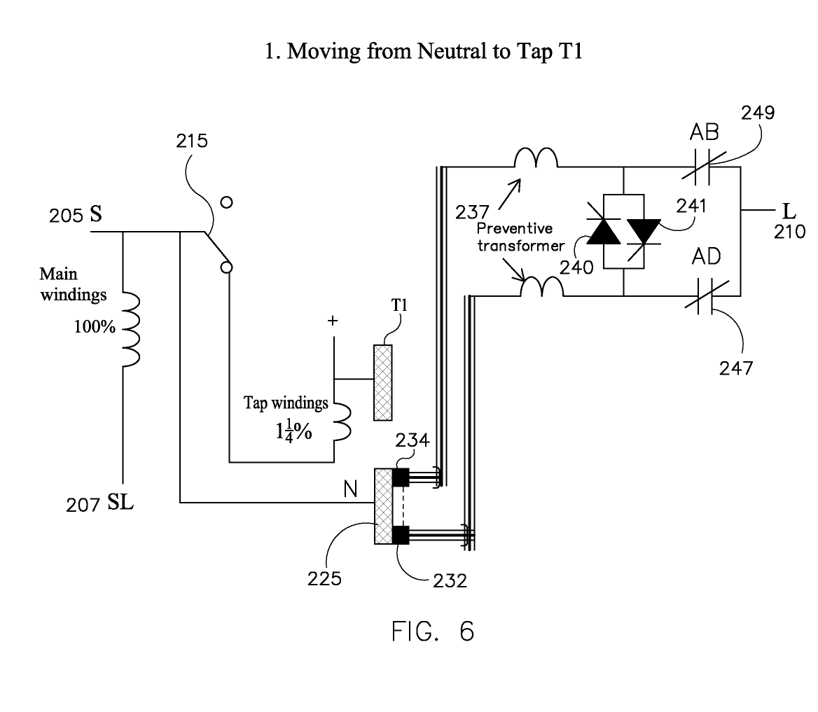

Referring now to FIGS. 6 through 11, an example tap changing operation for a voltage regulator using the foregoing example embodiments is described. Beginning with FIG. 6, a simplified version of the voltage regulator 200 illustrated in FIG. 2 is provided wherein only selected components are shown. FIG. 6 shows the voltage regulator 200 comprising a voltage sourer terminal 205, a neutral terminal 207, main windings, a voltage load terminal 210, and a portion of a tap changer. The portion of the tap changer shown in FIG. 6 includes movable contacts 232 and 234, neutral position tap 225, and first tap T1. The simplified version of the voltage regulator 200 in FIG. 6 also shows first and second switches 247 and 249, preventive transformer coils 237, and first SCR 241 and second SCR 240. In the first step of the tap changing operation illustrated in FIG. 6, the two movable contacts 232 and 234 are both in contact with the neutral position tap 225 and current is flowing through the closed first and second switches 247 and 749. As shown in FIG. 6, there is no voltage across the first SCR 241 and the second SCR 240 and the first SCR 241 and second SCR 240 are standing by and are prepared to receive a turn on signal at their gates.

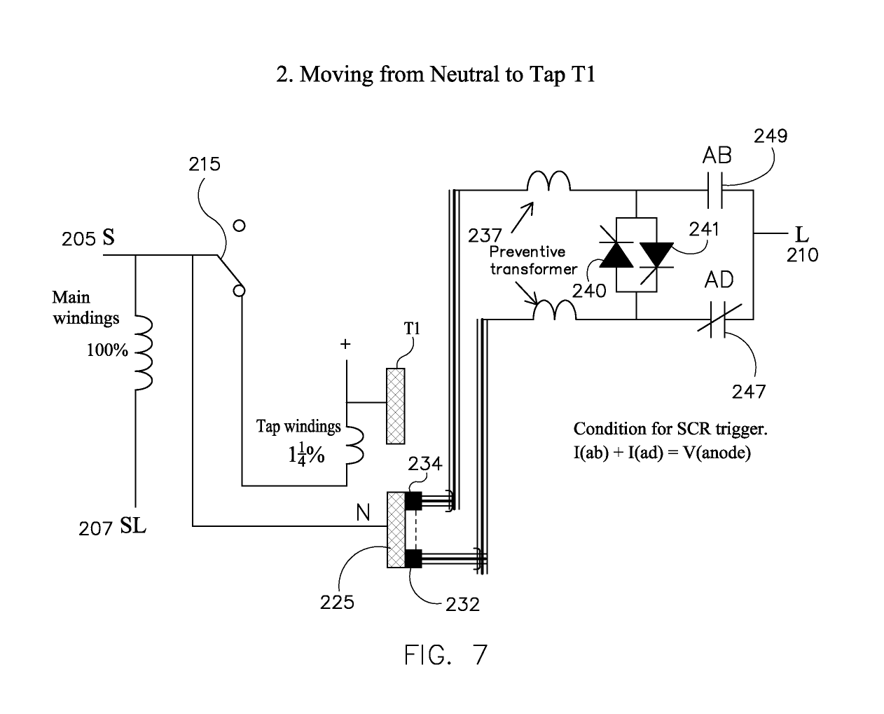

Referring now to FIG. 7, the next step in the tap changing operation is illustrated. In FIG. 7, the second switch 249 is opened. The second switch 249 may be opened by a controller operating the voltage regulator 200 and the switch may be opened by a mechanical linkage or an electrical control. When the second switch 249 is opened, the full load current is assumed by first switch 241, and, depending on the current polarity, either the first SCR 241 or the second SCR 240 momentarily assumes all of the load current. This occurs because the conditions for triggering one of the SCR gates are satisfied momentarily when the first and second current transformers 246 and 248 are still supplying current to the control circuits 244 and 245 and a there is a positive voltage at the anode of one of the SCRs when the switch 249 begins to open.

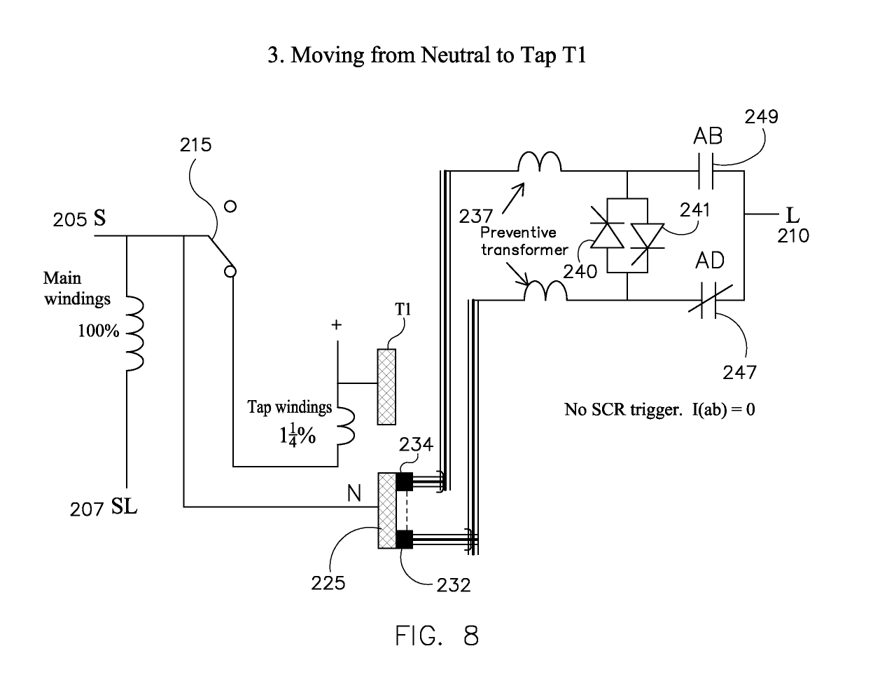

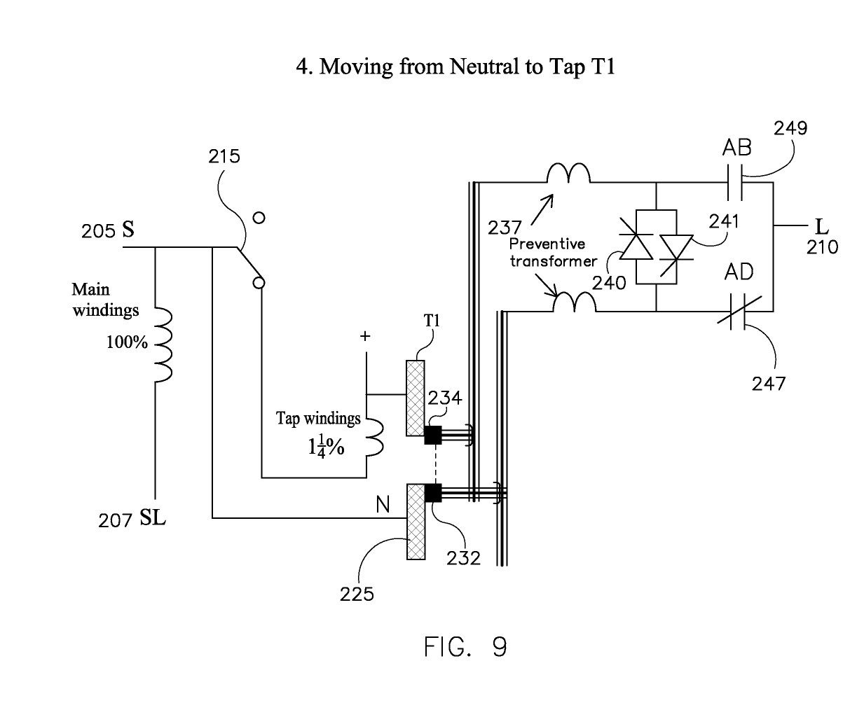

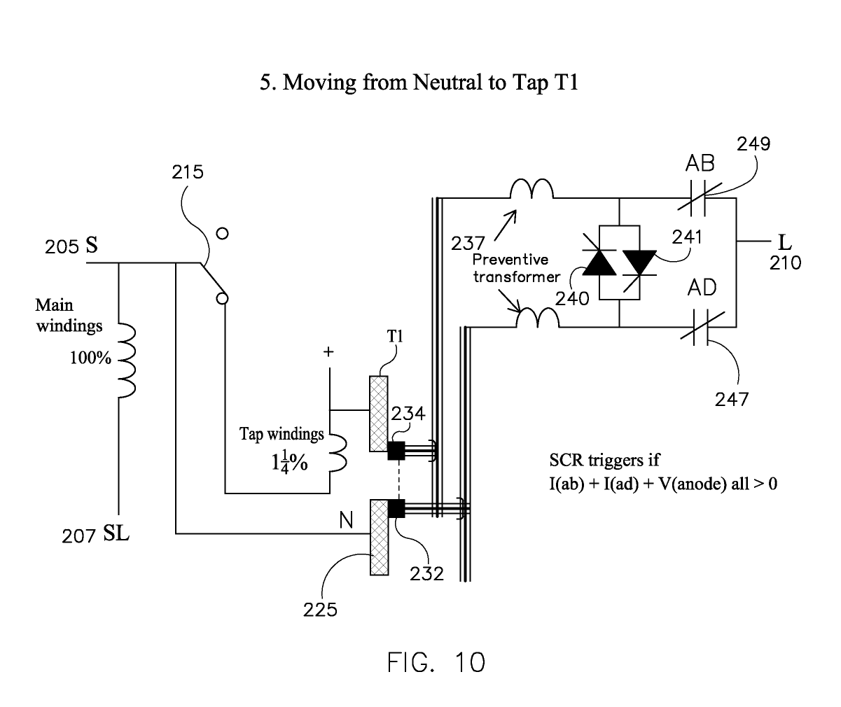

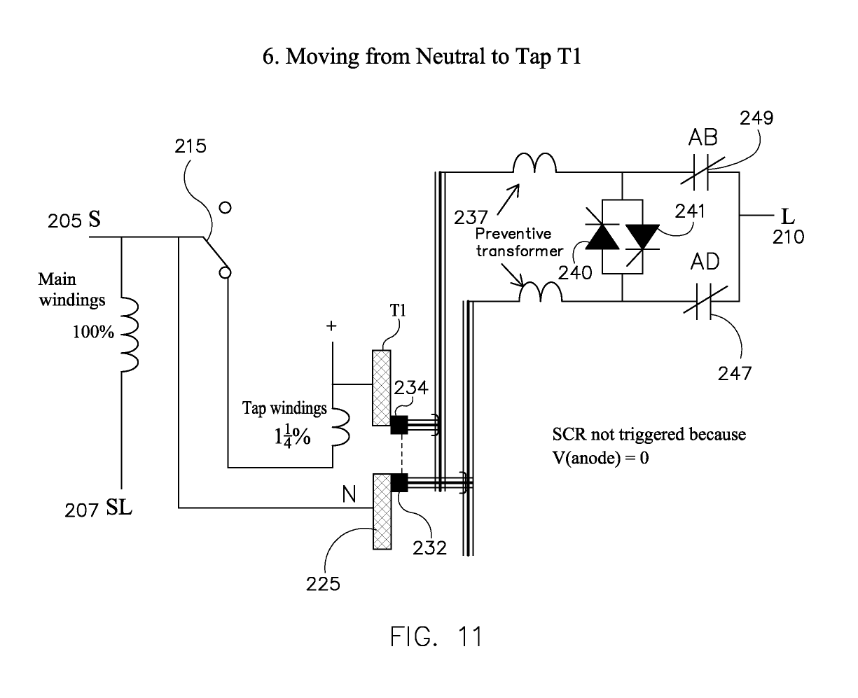

FIG. 8 shows the next step in the tap changing operation. In FIG. 8, after the second switch 249 has been opened and there is no longer current flowing though switch 249, the gate signals to the first SCR 241 and the second SCR 240 are turned off and the first SCR 241 and the second SCR 240 turn off after one or two half cycles. At this step of the process, there is no longer current flowing, through the conductor leading, to the second switch 249 and all the load current passes through the first switch 247.

Referring now to FIG. 9, the next step in the tap changing operation is illustrated. In FIG. 9, with the first SCR 241 and the second SCR 240 turning off after one or two half cycles, it is now safe for movable contact 234 to move from the neutral position tap 225 to the first tap T1 with the likelihood of an arc eliminated.

FIG. 10 illustrates the next step in the tap changing process. In FIG. 10, after the movement of the movable contact 234 to the first tap T1 is complete, the second switch 249 closes and if any significant voltage develops at the anode of either SCR as the closing switch begins to conduct current, immediately a gating signal is applied at one of the SCR gates because the three conditions are satisfied. In other words, the closing of the second switch 249 induces a current in the first and second current transformers 246 and 248 and provides a positive voltage at one of the SCR anodes. Gating of the first and second SCRs 241 and 240 provides a current path in the event that second switch 249 does not close in an ideal manner.

FIG. 11 illustrates the final step of the example tap changing operation illustrated in FIGS. 6 through 11. In FIG. 11, current is flowing at a steady state through first and second switches 247 and 249 and therefore the voltage at the SCR anode 434 is zero. In this step, the capacitors 420 of the control circuits 244 and 245 are charged so that the control circuits are ready to trigger the SCR gate in anticipation of the next tap change.

The foregoing example embodiments provide several improvements over prior art voltage regulators. The example embodiments described herein are able to handle higher surge currents and higher rates of current change at the SCR. The example embodiments also use components that require less power, have lower cost, and greater compatibility with the hot-oil environment of a voltage regulator. These improvements result in a voltage regulator with greater reliability than that found in the prior art.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A voltage regulator comprising:
a tap changer coupled to a voltage source terminal and comprising a plurality of stationary taps, a first movable contact, and a second movable contact, wherein the first and second movable contacts engage one or more of the plurality of stationary taps;
a voltage load terminal coupled to the tap changer;
a first switch and a first current transformer coupled in series between the voltage load terminal and the first movable contact;
a second switch and a second current transformer coupled in series between the voltage load terminal and the second movable contact;
a first silicon controlled rectifier (SCR) and a second silicon controlled rectifier (SCR), the first SCR and the second SCR oriented with respect to each other so that they are oppositely poled and coupled in parallel to each other and to the voltage load terminal;
a first control circuit coupled between the first SCR and the first and the second current transformers and a second control circuit coupled between the second SCR and the first and the second current transformers, wherein the first control circuit and the second control circuit each comprise:
a first rectifier and a second rectifier;
a gating switch that controls an SCR gate; and
a positive voltage detector coupled to an SCR anode and providing a signal to the gating switch when the positive voltage detector detects a positive voltage at the SCR anode.

2. The voltage regulator of claim 1, wherein detection of the positive voltage at the positive voltage detector of either the first control circuit or the second control circuit indicates incipient arcing at the first movable contact or the second movable contact.

3. The voltage regulator of claim 1, wherein a secondary coil of the first current transformer and a secondary coil of the second current transformer supply current to the first control circuit.

4. The voltage regulator of claim 1, wherein a secondary coil of the first current transformer and a secondary coil of the second current transformer supply current to the second control circuit.

5. The voltage regulator of claim 3, wherein the current supplied to the first control circuit is rectified and charges a first capacitor.

6. The voltage regulator of claim 5, wherein the first capacitor supplies a gating current to the SCR gate when the gating switch is closed.

7. The voltage regulator of claim 1, wherein the gating switch is closed when the positive voltage detector provides a signal to a signal AND gate and the first current transformer and second current transformer each provide a current transformer signal to the signal AND gate.

8. The voltage regulator of claim 6, wherein, after receiving the gating current, the SCR turns off when the gating current is removed and a current through the SCR goes to zero.

9. A method for operating a voltage regulator comprising the steps of:
supplying a load current from a source terminal to a load terminal through a tap changer of the voltage regulator, the tap changer comprising a first movable contact in contact with a first stationary tap and a second movable contact in contact with the first stationary tap, the voltage regulator comprising:
a first switch and a first current transformer coupled in series between the load terminal and the first movable contact through a first preventive transformer winding;
a second switch and a second current transformer coupled in series between the load terminal and the second movable contact through a second preventive transformer winding;
a first control circuit coupled to the first current transformer, the second current transformer, and a first silicon controlled rectifier (SCR); and
a second control circuit coupled to the first current transformer, the second current transformer, and a second silicon controlled rectifier (SCR);
initiating a tap change at the voltage regulator;
opening a first switch of the voltage regulator thereby causing: a first positive voltage detector to detect a positive voltage at a first anode of the first SCR, a first gating signal to be applied to the first SCR, a second positive voltage detector to detect a positive voltage at a second anode of the second SCR, and a second gating signal to be applied to the second SCR;
removing the first gating signal from the first SCR and the second gating signal from the second SCR thereby turning off the first SCR and the second SCR;
moving, by the tap changer, the first movable contact from the first stationary tap to a second stationary tap;
closing the first switch of the voltage regulator thereby preparing the first control circuit to apply the first gating signal to the first SCR and preparing the second control circuit to apply the second gating signal to the second SCR; and
supplying the load current from the source terminal to the load terminal via the first switch and the second switch.

10. The method of claim 9, wherein, after moving the first movable contact, the second control circuit applies the second gating signal to the second SCR when the first switch does not close properly.

11. The method of claim 9, wherein when the first gating signal is applied to the first SCR and the second gating signal is applied to the second SCR, the first SCR and the second SCR provide a path for the load current.

12. The method of claim 9, wherein the first gating signal is applied when: a) the load current is present in the first switch, b) the load current is present in the second switch, and c) the positive voltage is present at the first anode of the first SCR.

13. The method of claim 9, wherein the second gating signal is applied when: a) the load current is present in the first switch, b) the load current is present in the second switch, and c) the positive voltage is present at the second anode of the second SCR.

14. The method of claim 9, wherein the first gating signal is removed and the second gating signal is removed when there is no voltage at the first anode of the first SCR and the second anode of the second SCR.

15. The method of claim 9, wherein a secondary coil of the first current transformer and a secondary coil of the second current transformer supply a charging current to the first control circuit.

16. The method of claim 9, wherein a secondary coil of the first current transformer and a secondary coil of the second current transformer supply a charging current to the second control circuit.

17. The method of claim 9, wherein, after the first and second gating signals are applied, the first SCR and the second SCR turn off after a predetermined number of half cycles.

18. A voltage regulator comprising:
a tap changer coupled to a voltage source terminal and comprising a plurality of stationary taps, a first movable contact, and a second movable contact, wherein the first and second movable contacts engage one or more of the plurality of stationary taps;
a voltage load terminal coupled to the tap changer;
a first switch and a first current sensor coupled in series between the voltage load terminal and the first movable contact;
a second switch and a second current sensor coupled in series between the voltage load terminal and the second movable contact;
a first gated semiconductor device and a second gated semiconductor device, the first gated semiconductor device and the second gated semiconductor device oriented with respect to each other so that they are oppositely poled and coupled in parallel to each other and to the voltage load terminal;
a first control circuit coupled between the first gated semiconductor device and a power supply and a second control circuit coupled between the second gated semiconductor device and the power supply, wherein the first control circuit and the second control circuit each comprise:
a rectifier;
a gating switch that controls a gate of the gated semiconductor device; and
a positive voltage detector coupled to an anode of the gated semiconductor device and providing a signal to the gating switch when the positive voltage detector detects a positive voltage at the anode of the gated semiconductor.

19. The voltage regulator of claim 18, wherein detection of the positive voltage at the positive voltage detector of either the first control circuit or the second control circuit indicates incipient arcing at the first movable contact or the second movable contact.

20. The voltage regulator of claim 18, wherein the gating switch is closed when the positive voltage detector provides a signal to a signal AND gate and the first current sensor provides a sensed current signal to the signal AND gate.
